(19) United States
(12) Patent Application Publication
(10) Pub. No.: US 2013/0175136 A1
(43) Pub. Date: Jul. 11, 2013

(54) LOADING DEVICE AND METHOD

(71) Applicant: Padbro Pty Ltd, Tingalpa Queensland (AU)

(72) Inventors: Gregory Allan Padget, MANLY (AU); Leanne Marie Bruce, WYNNUM WEST (AU)

(73) Assignee: Padbro Pty Ltd, Tingalpa Queensland (AU)

(21) Appl. No.: 13/735,374

(22) Filed: Jan. 7, 2013

(30) Foreign Application Priority Data
Jan. 9, 2012 (AU) 2012900078

(51) Int. Cl. B65G 11/00; B65G 11/20

(52) U.S. Cl. CPC B65G 11/00; B65G 11/203
USPC 193/32; 193/2 R

(57) ABSTRACT

A loading device including a hollow body having, an inlet portion for receiving an animal; and an outlet portion connected to the inlet portion, the outlet portion for guiding the animal; wherein an opening of the inlet portion is larger than an opening of the outlet portion; and wherein the opening of the inlet portion slants inwardly towards the outlet portion, from a bottom front edge of the inlet portion to a top front edge of the inlet portion.

### CROSS REFERENCE TO RELATED APPLICATION

This application claims priority to Australian Patent Application No. 2012900078, filed Jan. 9, 2012, the disclosure of which is hereby incorporated by reference in its entirety.

### FIELD OF THE INVENTION

This invention relates generally to a loading device, and in particular to a device for loading poultry and other animals into a transportation cage.

### BACKGROUND TO THE INVENTION

Poultry, such as chickens and turkeys, are typically mass produced on large farms. Once the poultry have reached a certain size, they are transported from the farm to a processing centre. At the processing centre the poultry are slaughtered and processed, ready for sale to wholesalers and consumers.

In order to transport the poultry from the farm to the processing centre, the poultry are caught and loaded into a transportation cage or a coop by a catcher. Generally, each coop includes a number of bays, each bay holding a number of poultry, typically 10-25 birds, depending on their size. Each bay includes a hatch which is opened in order to load the poultry. Often four birds at a time are loaded into the poultry coop. The catcher fills one bay at a time and closes the hatch before loading a next bay. Once each bay of the coop has been filled with poultry, the coop is loaded onto a truck for transporting to the processing centre.

A problem with prior art poultry coops is that a considerable number of poultry sustain injuries from hitting the poultry coop whilst being loaded. Injuries include bruising, cuts and broken bones. Typically 30% of poultry will incur some sort of damage prior to presentation for processing and the damaged part will be classed as a “downgrade” and not used for human consumption. There is therefore a need for an improved device and method for loading poultry and other animals into a transportation cage.

The reference to any prior art in this specification is not, and should not be taken as, an acknowledgement or any form of suggestion that the prior art forms part of the common general knowledge.

### SUMMARY OF THE INVENTION

In one form, although not necessarily the only or broadest form, the invention resides in a loading device including:

a hollow body having:
an inlet portion for receiving an animal; and
an outlet portion connected to the inlet portion, the outlet portion for guiding the animal;

wherein an opening of the inlet portion is larger than an opening of the outlet portion; and

wherein the opening of the inlet portion slants inwardly towards the outlet portion, from a bottom front edge of the inlet portion to a top front edge of the inlet portion.

In another form the invention resides in a method of connecting a loading device to an animal cage including the steps of:

opening a hatch of the animal cage; and

connecting the loading device to an entrance of the animal cage; wherein the loading device includes:

a hollow body having:
an inlet portion for receiving an animal; and
an outlet portion connected to the inlet portion, the outlet portion for guiding the animal;

wherein an opening of the inlet portion is larger than an opening of the outlet portion; and

wherein the opening of the inlet portion slants inwardly towards the outlet portion, from a bottom front edge of the inlet portion to a top front edge of the inlet portion.

Preferably, the body of the loading device is hollow.

Preferably, the inlet portion and the outlet portion are integrally formed.

Preferably, the outlet portion comprises a rectangular tube.

Preferably, the outlet portion is configured for coaxial connection with the entrance of the animal cage.

Preferably, the outlet portion includes a stopper. Preferably the stopper is mounted to a top surface of the outlet portion. Alternatively, the top surface of the outlet portion includes a cut-out.

Preferably, the inlet portion tapers inwardly from the opening of the inlet portion towards the outlet portion. Preferably, the inlet portion is frusto-pyramidal in shape. Alternatively the inlet portion is frusto-conical in shape or an ovular frusto-conical shape.

Preferably, a bottom surface of the inlet portion and a bottom surface of the outlet portion are substantially flat and lie in a substantially same plane.

Preferably, the loading device is made from a plastic material. Alternatively, the loading device is made from metal such as aluminium or sheet steel.

Preferably, a rim of the inlet portion includes a protective cover.

### OBJECT OF THE INVENTION

It is an object, of some embodiments of the present invention, to provide consumers with improvements and advantages over the above described prior art, and/or overcome and alleviate one or more of the above described disadvantages of the prior art, and/or provide a useful commercial choice.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 shows a perspective view of a loading device installed in a poultry coop according to an embodiment of the present invention;

FIG. 2 shows a front perspective view of the loading device of FIG. 1 removed from the poultry coop;

FIG. 3 shows a side perspective view of the loading device of FIG. 2;

FIG. 4 shows a front perspective view of a loading device according to a second embodiment of the present invention; and

FIG. 5 shows a side perspective view of the loading device of FIG. 4.

### DETAILED DESCRIPTION OF THE DRAWINGS

Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element from another element without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention. It will be appreciated that the invention may be implemented in a variety of ways, and that this description is given by way of example only.

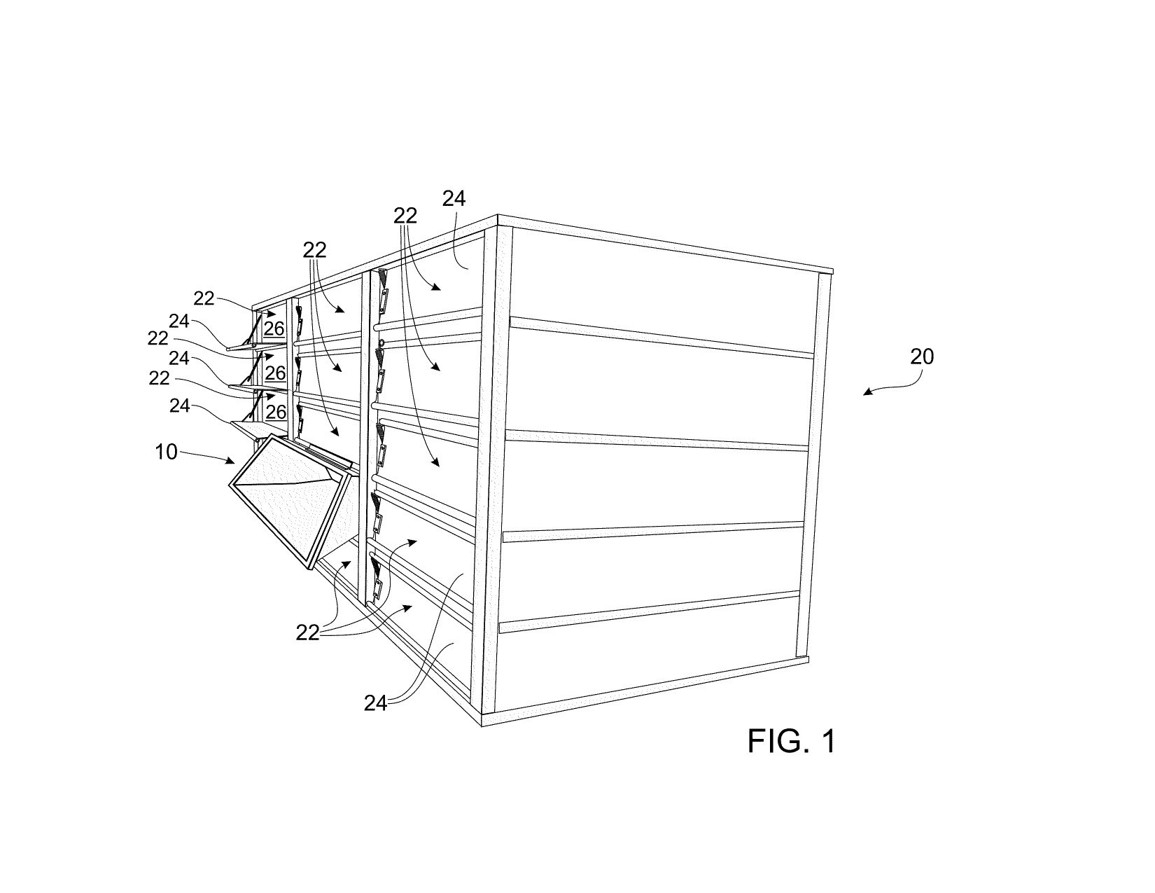

FIG. 1 shows a perspective view of a loading device 10 installed in an animal cage such as a poultry coop 20 according to an embodiment of the present invention. The poultry coop 20 includes a plurality of bays 22. Poultry are loaded into each bay 22 of the poultry coup 20 by opening a hatch 24, sliding the loading device 10 into an entrance 26 of the bay 22 and putting the poultry into the loading device 10.

An advantage of the loading device 10 of the present invention is that the poultry are less likely to sustain injuries from being knocked against an edge of the bay 22. This is because the loading device 10 effectively increases the size of an entrance 26 of the bay 22 and acts as a funnel to enable easier passage of the poultry into the bay 22.

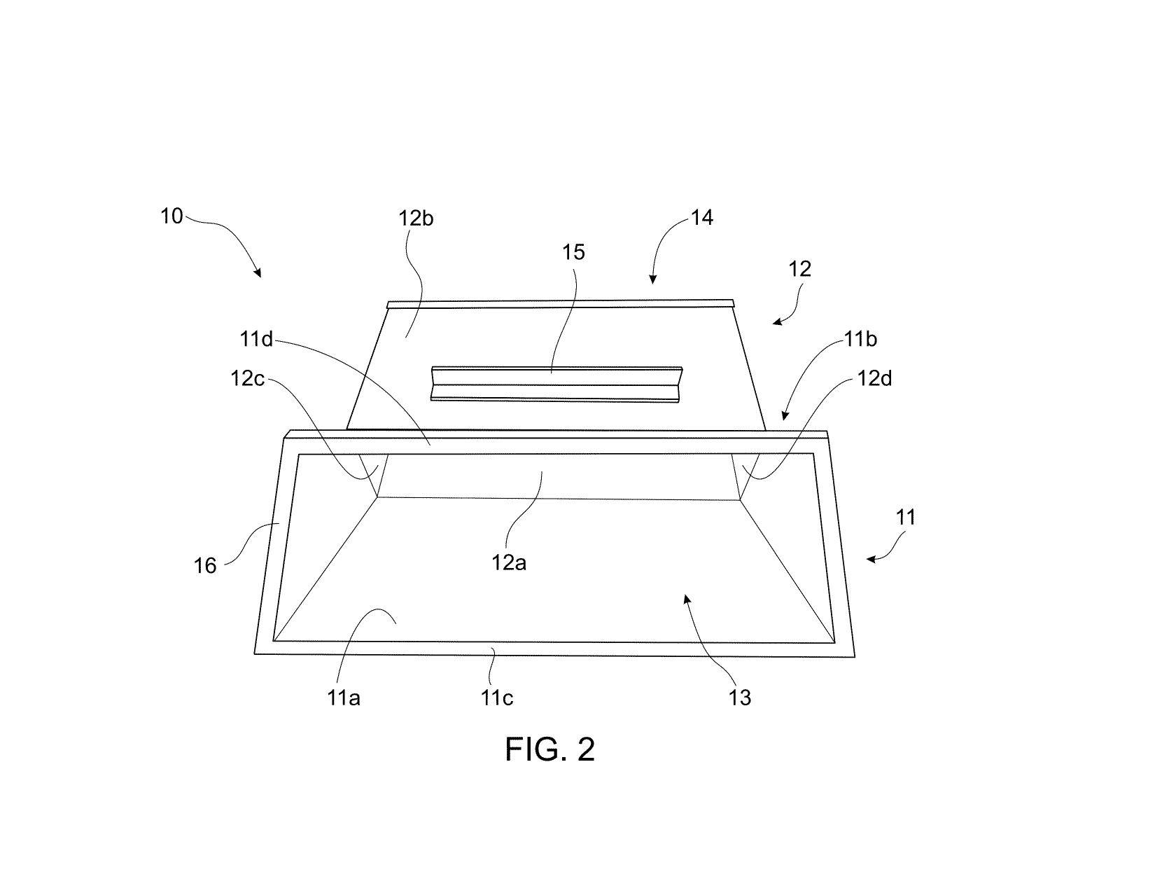

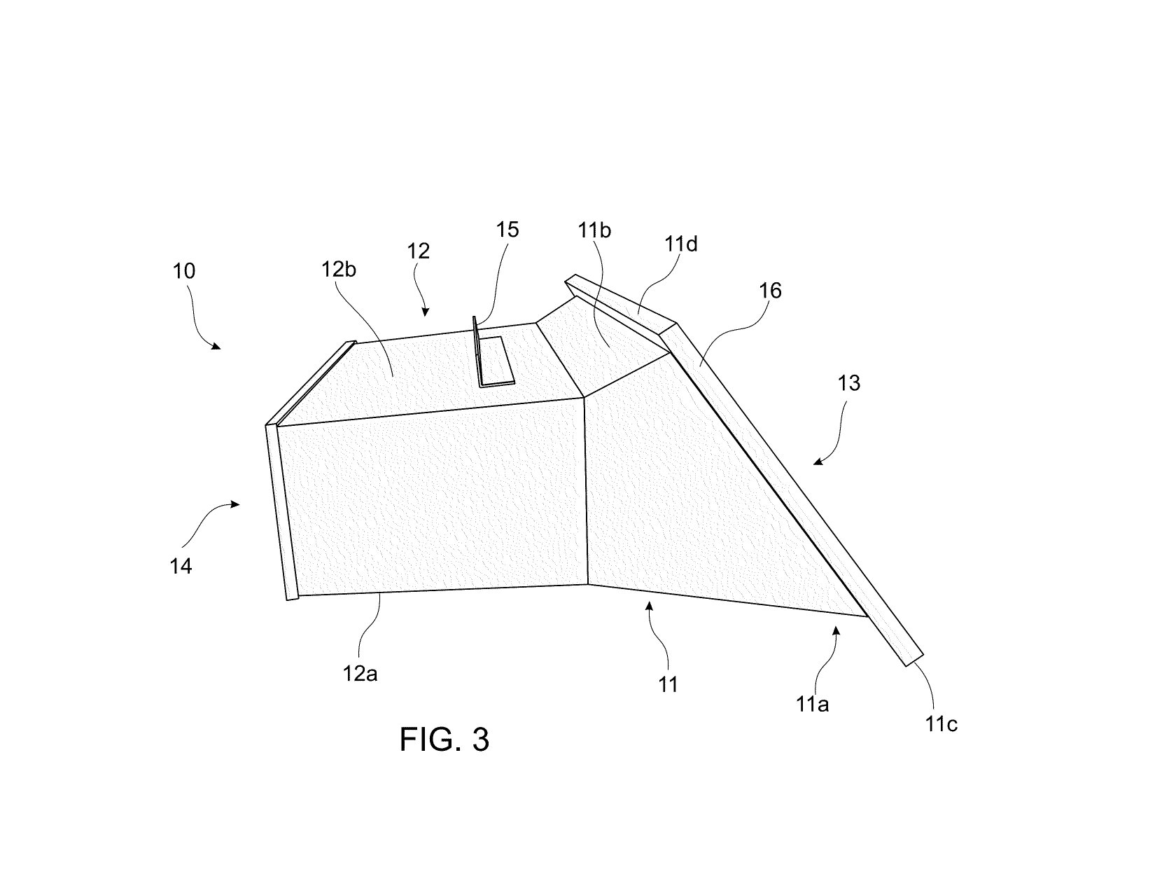

FIG. 2 shows a top view and FIG. 3 shows a side view of the loading device 10 of FIG. 1 removed from the poultry coop 20. Referring to FIGS. 1 to 3, the loading device 10 has a hollow body and includes an inlet portion 11 and an outlet portion 12. An opening 13 of the inlet portion 11 is larger than an opening 14 of the outlet portion 12.

The outlet portion 12 is configured to allow the passage of the poultry from the outlet portion 12 to the entrance 26 of the poultry coop 20. In one embodiment, the outlet portion 12 is a rectangular tube, and is coaxially connected to the entrance 26 by sliding the outlet portion 12 into the entrance 26. However it should be appreciated that the outlet portion 12 may be configured to connect to the entrance 26 using other mechanisms such as a quick release mechanism that connects to the entrance 26 of the outlet portion 12 of the poultry coop 20.

The loading device 10 also includes a stopper 15 mounted to a top surface 12b of the outlet portion 12. The stopper 15 is a length of angled metal which is fixed to the top surface 12b of the outlet portion 12 by welding or using a nut and bolt arrangement for example. The stopper 15 prevents the loading device 10 from extending too far into the bay 22 of the poultry coup 20 and fouling with a coop mechanism. It should be appreciated that the stopper 15 may additionally or alternatively be mounted to a bottom surface 12a of the outlet portion 12 or to sides 12c, 12d of the outlet portion 12. It should also be appreciated that the loading device 10 may not require a stopper 15.

The inlet portion 11 is integrally formed with the outlet portion 12 and tapers inwardly from an opening 13 of the inlet portion 11 to the outlet portion 12. The inlet portion 11 is a frusto-pyramid shape. However it should be appreciated that the inlet portion 11 may be any other shape for example frusto-conical or an ovular frusto-conical shape. Preferably, the opening 13 of the inlet portion 11 slants inwardly towards the outlet portion 12, from the bottom front edge 11c of the inlet portion 11 to a top front edge 11d of the inlet portion 11.

In another embodiment, the bottom surface 11a of the inlet portion 11 and a bottom surface 12a of the outlet portion 12 are substantially flat and 11e in a substantially same plane.

In one embodiment, a rim of the inlet portion 11 includes a protective cover 16 to protect animals or a catcher from sharp edges of the rim. However it should be appreciated the rim may not include the protective cover 16. The protective cover 16 may also further reduce injuries to the poultry, by providing a soft edge. The protective cover 16 may be made from any suitable materials such as foam or rubber. The protective cover 16 may be clipped or glued onto the rim or using any other securing mechanism.

In some embodiments, the loading device 10 is made from plastic. However it should be appreciated that the loading device 10 may be made from other materials such as metal and fibre glass. In some embodiments, the loading device 10 is moulded as a unitary part. However it should be appreciated that the loading device 10 may be made from sheet material and glued or welded together for example.

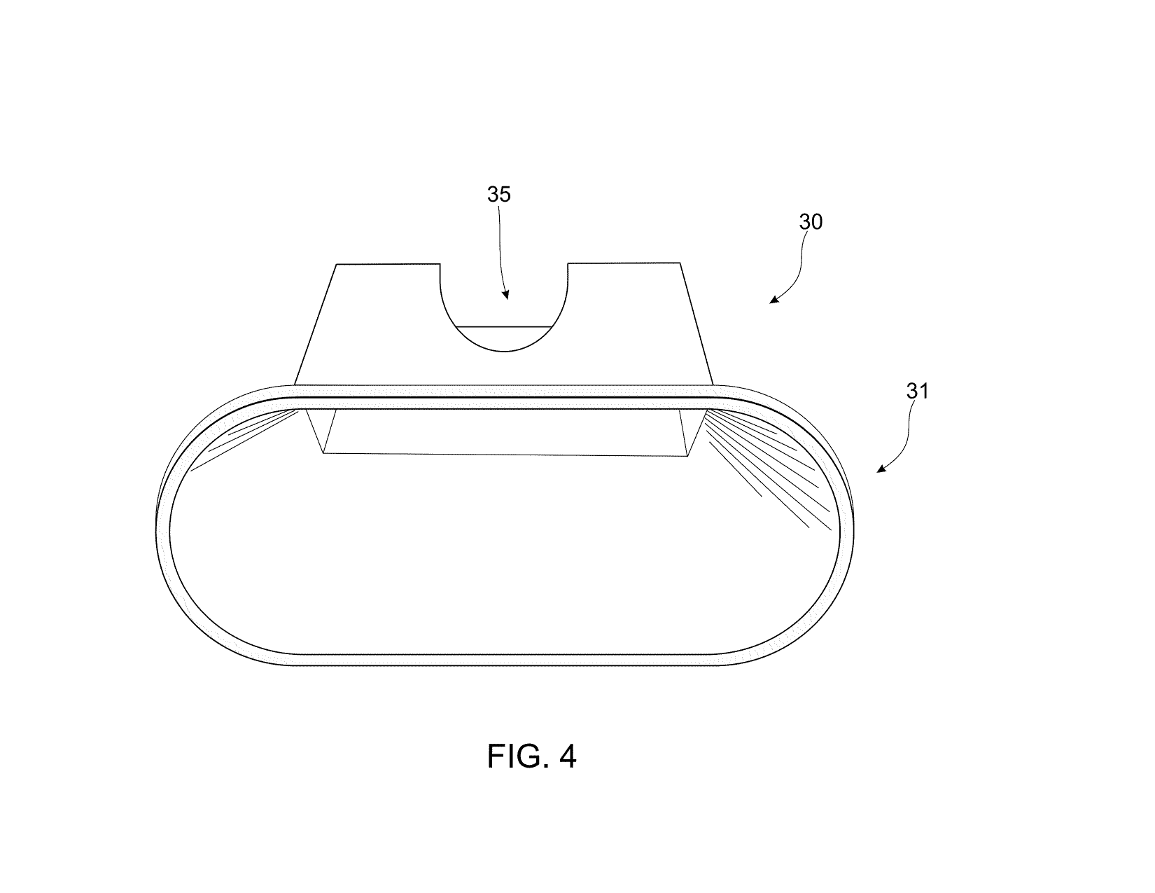

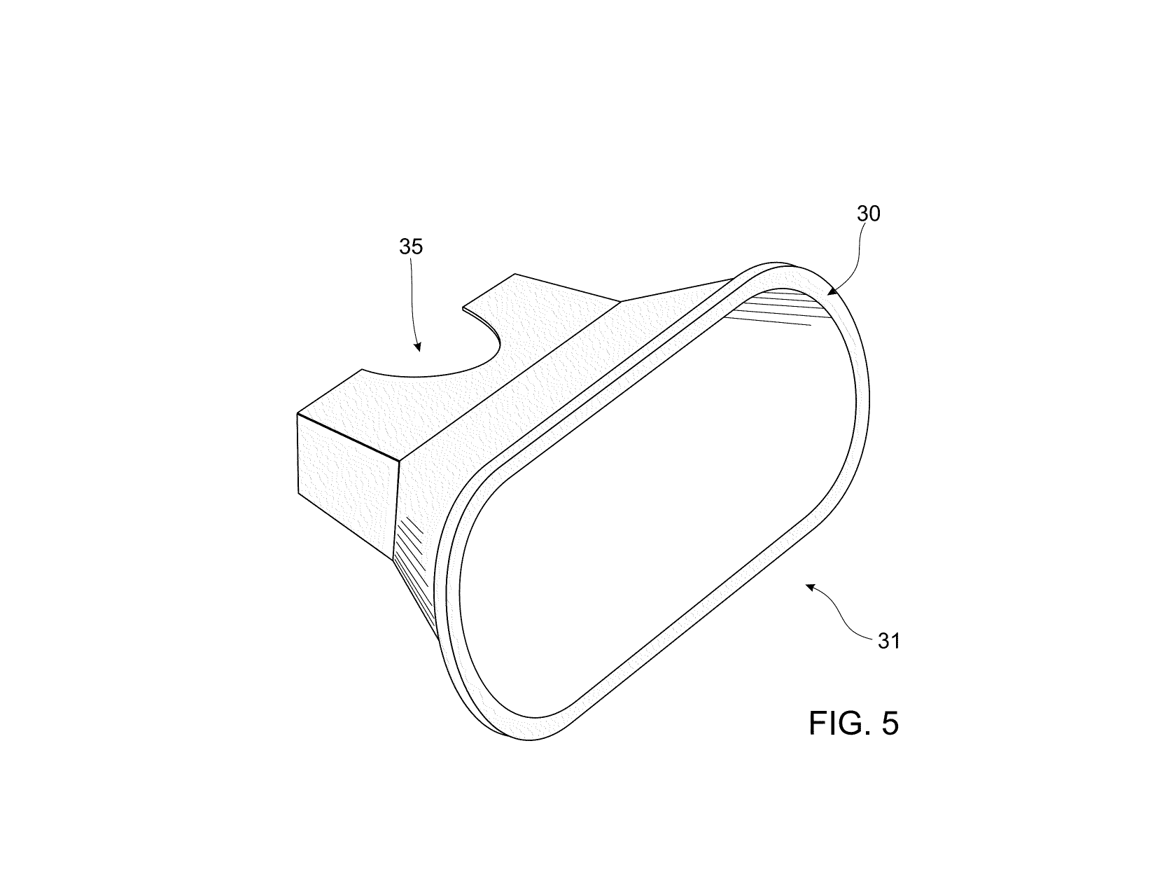

FIGS. 4 and 5 show a loading device 30 according to a second embodiment of the present invention. The loading device 30 is similar to the loading device 10 of FIGS. 1-3 with the exception that the loading device 30 is made from a moulded plastic. In addition, the loading device 30 includes a cut-out 35 instead of the stopper 15. Similar to the stopper 15, the cut-out 35 prevents the loading device from making contact with a coop mechanism (not shown). It should be appreciated that the stopper 15 of the loading device 10 of FIGS. 1-3 and the loading device 30 of FIGS. 4 and 5 may be used interchangeably. Furthermore, the loading device 10, 30 may include both the stopper 15 and the cut-out 35.

A further difference between the loading device 30 of FIGS. 4 and 5 and the loading device 10 of the loading device of FIGS. 1-3 is the shape of an inlet portion 31. In this embodiment, the inlet portion 31 is an ovular frusto-conical shape. However, as previously stated, it should be appreciated that the inlet portion 31 may be any applicable shape.

In use, the loading device 10 is connected to the entrance 26 of the poultry coop 20 by the catcher sliding the outlet portion 12 of the loading device 10 into the entrance 26 of the poultry coup 20. The loading device 10 is held in position due to the coaxial connection between the outlet portion 12 and the entrance 26. The catcher places poultry into loading device 10 which pass from the inlet portion 11 to the outlet portion 12 and into the poultry coop 20. It should be appreciated that the loading device 30 of FIGS. 4 and 5 is connected to the entrance 26 of the poultry coop 20 in a similar manner.

In summary, an advantage of the loading device of present invention is that it allows poultry to be loaded into poultry coops more easily due to the enlarged opening of the inlet portion. Furthermore, the enlarged opening reduces injuries sustained by poultry thus reducing the number of poultry that are rejected in downgrades.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. For example, although the present invention has been described in relation to poultry, it should be appreciated that the present invention may be adapted for use with other types of animal. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

What is claimed is:

1. A loading device including:
a hollow body having:
an inlet portion for receiving an animal; and
an outlet portion connected to the inlet portion, the outlet portion for guiding the animal;
wherein an opening of the inlet portion is larger than an opening of the outlet portion; and
wherein the opening of the inlet portion slants inwardly towards the outlet portion, from a bottom front edge of the inlet portion to a top front edge of the inlet portion.

2. The loading device of claim 1 wherein the outlet portion is configured for coaxial connection with the entrance of the animal cage.

3. The loading device of claim 1 wherein the inlet portion and the outlet portion are integrally formed.

4. The loading device of claim 1 wherein the outlet portion comprises a substantially rectangular tube.

5. The loading device of claim 1 wherein the outlet portion includes a stopper.

6. The loading device of claim 5 wherein the stopper is mounted to a top surface of the outlet portion.

7. The loading device of claim 1 wherein a top surface of the outlet portion includes a cut-out.

8. The loading device of claim 1 wherein the inlet portion tapers inwardly from the opening of the inlet portion towards the outlet portion.

9. The loading device of claim 1 wherein the inlet portion is frusto-pyramidal in shape.

10. The loading device of claim 1 wherein the inlet portion is frusto-conical in shape

11. The loading device of claim 1 wherein the inlet portion is an ovular frusto-conical shape.

12. The loading device of claim 1 wherein the loading device is made from a plastic material.

13. The loading device of claim 1 wherein the loading device is made from metal.

14. The loading device of claim 1 wherein a rim of the inlet portion includes a protective cover.

15. The loading device of claim 1, wherein a bottom surface of the inlet portion and a bottom surface of the outlet portion are substantially flat and lie in a substantially same plane.

16. A method of connecting a loading device to an animal cage including the steps of:
opening a hatch of the animal cage; and
connecting the loading device to an entrance of the animal cage; wherein the loading device includes:
a hollow body having:
an inlet portion for receiving an animal; and
an outlet portion connected to the inlet portion, the outlet portion for guiding the animal;
wherein an opening of the inlet portion is larger than an opening of the outlet portion; and
wherein the opening of the inlet portion slants inwardly towards the outlet portion, from a bottom front edge of the inlet portion to a top front edge of the inlet portion.
